(19) United States
(12) Patent Application Publication
(10) Pub. No.: US 2025/0124953 A1
(43) Pub. Date: Apr. 17, 2025

(54) METHOD, DEVICE, APPARATUS AND STORAGE MEDIUM FOR VIDEO PRODUCTION

(71) Applicant: Beijing Zitiao Network Technology Co., Ltd., Beijing (CN)

(72) Inventors: Lingyun Chen, Beijing (CN); Lili Fang, Beijing (CN); Changchun Li, Beijing (CN); Yu Mao, Beijing (CN); Bo Li, Beijing (CN); Hao Liu, Beijing (CN); Xin Xu, Beijing (CN); Yiming Wang, Beijing (CN); Xin Zhou, Beijing (CN); Fan Yang, Beijing (CN)

(21) Appl. No.: 18/913,939

(22) Filed: Oct. 11, 2024

(30) Foreign Application Priority Data
Oct. 13, 2023 (CN) 202311330972.2

(51) Int. Cl. G11B 27/031; G06F 40/10

(52) U.S. Cl. CPC G11B 27/031; G06F 40/10

(57) ABSTRACT

Embodiments of the disclosure provide a method, a device, an apparatus, and a storage medium for video production. The method includes: presenting a text setup interface in a displayed video producing window; receiving a first trigger operation; displaying object attribute information corresponding to the video production object in the first information display area; receiving a second trigger operation; and displaying, in the second information display area, video related text corresponding to the video production object. According to the method, a simple and easy operation video production platform is provided for a video producer. A text setting interface of a video to be manufactured is presented on the video production platform, and a function item for video text generation is provided for the video producer.

### CROSS-REFERENCE

This application claims priority to Chinese Patent Application No. 202311330972.2 filed on Oct. 13, 2023, and entitled “METHOD, DEVICE, APPARATUS AND STORAGE MEDIUM FOR VIDEO PRODUCTION”, the entirety of which is incorporated herein by reference.

### FIELD

The embodiments of the present disclosure relate to the technical field of video processing, and in particular, to a method, a device, an apparatus, and a storage medium for video production.

### BACKGROUND

The Internet technology is widely used in people's lives, and people can share the content to be shared in different forms through the network for more people to watch and understand. In video form sharing as a currently common sharing manner, people can make the content to be shared as a video and realize video sharing on a network platform.

In the implementation and maintenance of video sharing by a video sharer through a network platform, one key link is to make a video. In order to share more abundant video content that can attract the interest of an audience, it is often necessary to edit or modify the captured original video or some material to realize secondary production of the original video or material. The secondary production form may include rearranging the multiple videos and/or pictures, splicing the multiple videos and/or pictures, and adding a clip element, such as an effect, a transition field, a flower word, and music, in the video. In addition, in order to make the video more attractive, a video script design is also added in video production.

The current video production methods, if aiming to achieve the display effects mentioned above, often require the involvement of professional video producers using specialized video editing software. The video production process is mainly edited manually by a producer making the entire video production time-consuming and labor-intensive. When a video sharer needs to share more video content for attracting more audiences, more manpower and time cost needs to be put for video production. The existing video production manner increases the generation difficulty and cost input of the video content.

### SUMMARY

The present disclosure provides a method, apparatus, device and a storage medium for video production, so that the generation process of the video related text is relatively intelligent and simple, and the time and labor cost input by text generation are reduced.

In a first aspect, embodiments of the present disclosure provides a method for video production, comprising:
presenting a text setup interface in a displayed video producing window, the text setup interface comprising: an information edit area, a first information display area, and a second information display area;
receiving a first trigger operation, wherein the first trigger operation triggers a first trigger control comprised in the information edit area after object association information of a video production object is inputted to an information edit box included in the information edit area;
displaying object attribute information corresponding to the video production object in the first information display area, the object attribute information being determined based on the object association information;
receiving a second trigger operation, wherein the second trigger operation triggers a second trigger control comprised in the first information display area; and
displaying, in the second information display area, video related text corresponding to the video production object, the video related text being generated based on the object attribute information.

In a second aspect, embodiments of the present disclosure further provide an apparatus for video production, comprising:
a setup interface presenting module configured to present a text setup interface in a displayed video producing window, the text setup interface comprising: an information edit area, a first information display area, and a second information display area;
a first receiving module configured to receive a first trigger operation, wherein the first trigger operation triggers a first trigger control comprised in the information edit area after object association information of a video production object is inputted to an information edit box included in the information edit area;
a first display module configured to display object attribute information corresponding to the video production object in the first information display area, the object attribute information being determined based on the object association information;
a second display module configured to display, in the second information display area, video related text corresponding to the video production object, the video related text being generated based on the object attribute information;
a second display module configured to display, in the second information display area, video related text corresponding to the video production object, the video related text being generated based on the object attribute information.

In a third aspect, embodiments of the present disclosure further provides an electronic device, comprising:
one or more processors; and
a storage device configured to store one or more programs;
when the one or more programs are executed by the one or more processors, the one or more processors implement the method for manufacturing a video according to any embodiment of the present disclosure.

In a fourth aspect, the embodiments of the present disclosure further provide a computer-readable storage medium with a computer program stored thereon, when the program is executed by a processor, causing the one or more processors to implement the method of any embodiments of this present disclosure.

### BRIEF DESCRIPTION OF DRAWINGS

In conjunction with the accompanying drawings and with reference to the following detailed description, the above and other features, advantages and aspects of the various embodiments of the present disclosure will become more apparent. Throughout the drawings, similar or same reference numerals denote similar or same elements. It should be understood that the drawings are illustrative and that the elements are not necessarily drawn to scale.

FIG. 1A gives a schematic flowchart of a method for video production provided by an embodiment of the present disclosure;

FIG. 1B gives an example diagram of a text setup interface in the method for video production provided by this embodiment;

FIG. 2A gives an example diagram of a material uploading interface in the method for video production provided by this embodiment;

FIG. 2B gives a further example diagram of a material uploading interface in the method for video production provided by this embodiment;

FIG. 3A gives an example diagram of a video preview interface in the method for video production provided by this embodiment;

FIG. 3B is a further example diagram of a video preview interface in the method for video production provided by this embodiment;

FIG. 3C gives a further example diagram of a video preview interface in the method for video production provided by this embodiment;

FIG. 3D gives a further example diagram of a video preview interface in the method for video production provided by this embodiment;

FIG. 3E gives a further example diagram of a video preview interface in the method for video production provided by this embodiment;

FIG. 4A gives an example diagram of a video export interface in a method for video production provided by this embodiment;

FIG. 4B gives a further example diagram of a video export interface in a method for video production provided by this embodiment;

FIG. 5 is a schematic structural diagram of a video production apparatus provided by an embodiment of the present disclosure;

FIG. 6 is a schematic structural diagram of an electronic device provided by an embodiment of the present disclosure.

### DETAILED DESCRIPTION

The embodiments of the present disclosure will be described in more detail with reference to the accompanying drawings. Although some embodiments of the present disclosure are shown in the accompanying drawings, it should be understood that the present disclosure may be implemented in various manners, and thus should not be construed as limited to embodiments elaborated herein, on the contrary, these embodiments are provided for a more thorough and complete understanding of the present disclosure. It should be understood that the accompanying drawings and attachments disclosed herein are for illustrative purposes only and are not intended to limit the scope of protection of this disclosure.

It should be understood that the various steps described in the method implementation method of this disclosure may be executed in different orders and/or in parallel. In addition, the method implementation method can include additional steps and/or omit the steps shown. The scope of this disclosure is not limited in this regard.

The term “including” and its variations used herein are not exclusive, which means “including but not limited to”. The term “based on” means “at least partially based on”. The term “one embodiment” means “at least one embodiment”; the term “a further embodiment” means “at least one further embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, and are not used to limit the order or interdependence of the functions performed by these devices, modules, or units.

It should be noted that the modifications of “one” and “a plurality of” mentioned in this disclosure are illustrative and not restrictive. Those skilled in the art should understand that unless otherwise specified in the context, they should be understood as “one or more”.

The names of the messages or information exchanged between a plurality of devices in the present disclosure are for illustrative purposes only and are not intended to limit the scope of these messages or information.

It may be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server, or a storage medium, that performs the operation of the technical solution of the present disclosure based on the prompting information.

As an optional but non-limiting implementation, in response to receiving the active request of the user, the manner of sending the prompt information to the user may be, for example, a pop-up window. The prompt information may be presented in a text manner in the pop-up window. Furthermore, the pop-up window may further carry a selection control for the user to select “agree” or “not agree” to provide personal information to the electronic device.

It may be understood that the foregoing notification and obtaining a user authorization process is only schematic, and does not constitute a limitation on implementations of the present disclosure. Other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

It may be understood that, the network platform refers to a platform that may be used for video publishing. Some account managers may operate their accounts on the network platform. The operation process mainly involves publishing videos of interest to some audiences. Currently, when there is a need for video publishing on a network platform, one key link is to make video production. In order to release more abundant video content that can attract the interest of an audience, it is often necessary to edit or modify the captured original video or some material, to implement secondary manufacturing on the original video or material. The secondary production form may include re-arranging and combining multiple videos and/or pictures, and adding a clip element, such as an effect, a transition field, a flower word, and music, in the video. In addition, in order to make the video more attractive, the video text design is also added in video production.

At present, if a video capable of achieving the above display effect needs to be produced, it is often necessary to invite a professional video producer to participate in production through professional video production software. This production process mainly relies on manual editing by the producers, making the entire video production time-consuming and labor-intensive. When a video publisher needs to publish more video content for attracting more audiences, more manpower and time costs are required for video production. The existing video production method increases the generation difficulty and cost input of video content.

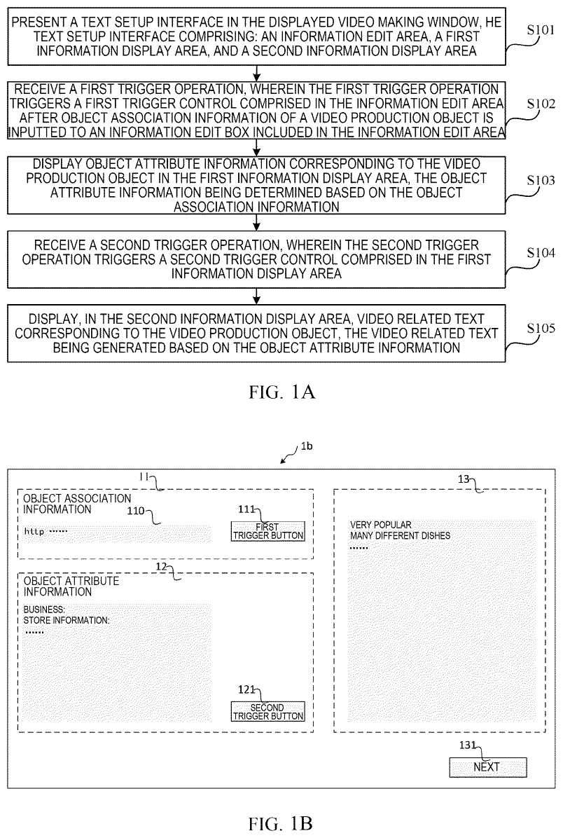

Based on this, an embodiment of the present disclosure provides a method for video production. FIG. 1A gives a schematic flowchart of a method for video production provided by an embodiment of the present disclosure. The embodiments of the present disclosure are applicable to a video production situation. The method may be performed by a video production apparatus. The apparatus may be implemented in a form of software and/or hardware, or optionally, implemented by an electronic device. The electronic device is preferably a mobile terminal, a desktop computer, a notebook computer, a server, and the like.

It may be understood that the execution object of the video production method provided in this embodiment may be a video production platform using the electronic device as the execution carrier. For example, the video producer may enter the video production platform through the running entry of the trigger video production platform in the electronic device. The video production method is specifically implemented on the video production platform by using the video production method provided in this embodiment.

As shown in FIG. 1A, a method for video production provided by an embodiment of the present disclosure may specifically include:

S101: present a text setup interface in the displayed video making window, where the text setup interface includes: an information edit area, a first information display area, and a second information display area.

This embodiment provides a simple and intelligent video production method, which enables a video producer to make a video of interest to a user in batches by using the video production method provided in this embodiment. The process of making the video by the video producer based on the video manufacturing method provided in this embodiment may be considered to be performed in an order of preset video production processes. Different from the conventional technical solution that requires professional matching of material to write text, and then designing effects, flower character transitions, etc., the video production method provided by this embodiment in this technical solution may be used to sequentially execute each production node in accordance with the guidance of the video production process, ultimately realizing the batch production of the video. In this embodiment, the video production process based on the realization of video production may include a plurality of production nodes, and at each production node, a node interface corresponding to the production node may be presented in the video production window, and the node interface may be named differently according to the different production requirements corresponding to the production node.

In this embodiment, the text setup interface may be considered to be the node interface corresponding to the text production node contained in the video production process, and the production requirements corresponding to the text production node may be considered to use the production of the text content contained in the video. In this embodiment, the text production node may be regarded as the first to-be-executed production node in the video production process. For example, after starting a video production function application, a video production window may be popped up, and the text production node may directly present a text setup interface corresponding to the text production node in the video production window.

In this embodiment, the text setup interface includes: an information edit area, a first information display area, and a second information display area. The information edit area may be understood as an editable area for inputting the associated information corresponding to the video production object. The information edit area may include an information editing box and a trigger control that is associated with the information editing box on the bottom layer design. This embodiment may note that the trigger control is the first trigger control. The video production object described in this embodiment is understood to be the entity object that should be included in the video to be produced, which may be a character, an animal or plant, or a certain item, a store or even a building, etc., and this embodiment is not specifically limited.

Exemplarily, the association between the first trigger control and the information edit box may be reflected in the following: the video producer may input the associated information corresponding to the video production object in the information edit box. After the first trigger control is triggered and the completion of the information filling, the video producer can perform the processing operation on the information input in the information edit box. Specifically, the information input in the information edit box may be object association information of the video production object. The object association information may be object access link information or content extraction path information of the video production object. The first trigger control may be understood as an parsing trigger control for performing information parsing on the information input in the information edit box. By triggering the first trigger control, the input information may be parsed to obtain the object content related to the video production object. It should be known that the video producer edits the information input in the information editing box. The editing operation may include operations such as adding, deleting, or modifying.

In this embodiment, the first information display area may be understood as an area for displaying object attribute information corresponding to the video production object, where the object attribute information may be determined by using the object association information input in the information edit area. The object attribute information may include object basic description information, for example, information such as a name, a location, and a service function of the object. The object attribute information may further include information such as object label information, performance that may be achieved by the object, and comparison information of the object and other object.

It should be noted that the first information display area also includes a trigger control. This embodiment may mark the trigger control as a second trigger control, where it may also be considered that the second trigger control is triggered and associated with the first information display area on the underlying design. For example, the trigger association may be reflected in: after the object attribute information of the video production object is displayed in the first information display area, the second trigger control is triggered. The processing operation on the object attribute information may be performed. It should be noted that, for the object attribute information displayed in the first information display area, the object attribute information also has an editing function. Moreover, the video producer may also edit the object attribute information according to the requirements of the video producer, for example, add, delete, modify, etc.

In this embodiment, the second information display area may be configured to display video related text. The video related text may be used for subsequent video production. The video related text may be considered as text information related to the video production object included in the generated video. The video related text may be obtained by processing the object attribute information in the first information display area.

It may be understood that the text setup interface may further include other areas. For example, the text setup interface may further include an application scene selection area. The application scene selection area may be provided with a short video playing option and a short video script option. The video producer may select a corresponding application scenario according to own requirements. Moreover, based on the selected application scenario, it may be determined whether the generated video related text is a short video playing type or a short video script type. This embodiment does not specifically limit all areas included in the text setup interface.

Specifically, after the video making function is triggered, the text setup interface may be presented in the displayed video making window. The text setup interface may receive the information input by the video producer, or may display the corresponding information.

FIG. 1b gives an example diagram of a text setup interface in the execution of a method for video production provided by the present embodiment. Specifically, after triggering of a video production control presented on a video production platform, the text setup interface 1b shown in FIG. 1B is presented. The text setup interface 1b includes an information edit area 11, a first information display area 12, and a second information display area 13. The information edit area 11 includes an information editing box 110 and a first trigger control 111 (presented as a button form in the figure). The first information display area 12 includes a second trigger control 121 (also presented as a button form). In addition, a NEXT execution control 131 is disposed below the entire text setup interface 1b. The video producer may input or import the object association information corresponding to the video production object in the information editing box 110, and trigger the first trigger control 111 to perform the processing operation of the object association information. Thus, the object attribute information displayed in the first information display area 12 may be obtained. Then the processing operation of the object attribute information may be performed by triggering the second trigger control 121, so that the video related text displayed in the second information display area 13 may be obtained.

In this step, after the video production window is entered, the interface corresponding to the first production node is displayed according to the flow information of the preset video production process. The production node may be a text production node. The corresponding interface is denoted as a text setup interface. The text setup interface includes an information edit area, a first information display area, and a second information display area related to the production of the video text required when the video producer is guided to make a video, wherein the information edit area, the first information display area, and the second information display area may both be regarded as function modules provided in the video production platform. These function modules may be considered as execution paths generated for the video related text provided by the video producer.

S102: receive a first trigger operation, wherein the first trigger operation triggers a first trigger control comprised in the information edit area after object association information of a video production object is inputted to an information edit box included in the information edit area.

It may be understood that when the video producer performs video making or video sharing. It may be predetermined that what video is desired to be generated. Moreover, the target object that is intended to be included in the video may be determined. In this embodiment, the target entity or object to be included in the generated video may be denoted as a video production object. The video to be generated may then be unfolded around the selected video production object. Object content related to a video production object may be presented in the produced video as object related information of the video production object.

In this embodiment, to realize the above logic, the video producer may be guided to enter relevant information of the video production object in the information editing box of the information editing area in the text setup interface, which is recorded as the object association information. Taking a certain shop as a video production object as an example, the object association information may be access link information related to accessing the shop related page, or storage path information for storing the shop related information.

It may be understood that the first trigger control may be specifically used as a trigger control for triggering analysis processing on the input object association information. The first trigger operation received in this step may be considered as generated when the first trigger control is triggered after the object association information of the video production object is input in the information edit box. Considering the association between the first trigger control and the information edit box in the underlying design, after receiving the first trigger operation in this step, the first trigger operation may be responded to by executing the following S103.

S103: display object attribute information corresponding to the video production object in the first information display area, the object attribute information being determined based on the object association information.

As described above, in this embodiment, after receiving the first trigger operation, the information page associated to the video production object may be accessed according to the object association information in the information edit box. Moreover, the object service information of the video production object included in the information page may be parsed to obtain the object attribute information of the video production object. The object attribute information may be displayed in the first information display area by this step.

It may be learned that the object attribute information may be considered as being determined based on the object association information, where one determination manner may be described as accessing the information page including the related service information of the video production object based on the object association information. The related service information in the information page may be parsed to extract the object attribute information of the video production object from the related service information The object attribute information displayed in the first information display area may be considered as the key information in the related service information of the video production object.

The related service information may include object label information, for example, a category to which the object belongs, a type of the object, and the like. Moreover, the related service information may further include object function description information, for example, which service functions are actually provided for the description object. Alternatively, the related service information may include object performance description information, for example, what performance effect is actually generated by the service function provided by the description object. In the underlying implementation support of this step, the related service information of the video production object in the information page may be parsed to obtain the basic attribute (such as the name, the location, the construction time, etc.) of the video production object, the service function, and the text content with the performance of the service function as the object attribute information.

For example, with continued reference to FIG. 1B, the video producer may input object association information corresponding to the video production object in the information editing box 110 of the information edit area 11. Then the video producer may trigger the first trigger control button 111 to obtain the object attribute information based on the input object association information and display the object attribute information of the video production object in the first information display area 12.

S104: receive a second trigger operation, wherein the second trigger operation triggers a second trigger control comprised in the first information display area.

It may be understood that, after specifying the video production object for video production,, the object association information related to the video production object is simply input in the information editing box of the information edit area. Thus, some information page containing the object related information may be obtained based on the object association information. Moreover, the object related information in the information page may be extracted to obtain the object attribute information and displayed in the first information display area. Subsequently, when the video related text generation, the object attribute information of the video production object may be obtained from the first information display area. The video related text of the video production object may be generated based on the object attribute information.

In this embodiment, In this embodiment, to realize the generation of video related text, the video producer may be guided to trigger the second trigger control in the first information display area of the text setup interface. The second trigger operation generated after the second trigger control is triggered may be received in this step. The second trigger control may be preferably a second trigger control. The second trigger control may be specifically understood as a control required for generating the video related text. Considering the association between the second trigger control and the first information display area in the underlying design, the second trigger control is associated with the first information display area on the underlying design. After receiving the second trigger operation in this step, the second trigger operation may be responded to by the following execution of S105.

S105, display, in the second information display area, video related text corresponding to the video production object, the video related text being generated based on the object attribute information.

In this embodiment, after the first information display area displays the object attribute information and the second trigger control is triggered, the second trigger operation may be received through the foregoing steps. The execution of the second trigger operation may be responded to by this step. The video related text generated based on the object attribute information is displayed in the second information display area.

In this embodiment, the video related text corresponding to the video production object may be displayed in the second information display area, which is based on the underlying technical support. For example, after the second trigger control is triggered, the executing entity may obtain object attribute information corresponding to the video production object displayed in the first information display area. Moreover, the executing entity may input the object attribute information into the trained text generation model, to obtain an output result as the video related text, and display the video related text in the second information display area.

In this embodiment, the video related text may be considered as text content information that is subsequently presented in the generated video. The video related text may include video title information and text content to be displayed in the video, where the text content to be displayed in the video may be playing text information or video script description information included in the video.

For example, continuing to refer to FIG. 1B, after the object attribute information of the video production object is displayed in the first information display area 12, the video producer may trigger the second trigger control 121. By triggering the second trigger control 121, the video related text may be generated based on the object attribute information in the first information display area 12 and the video related text may be displayed in the second information display area 13.

It may be understood that, when performing video production based on the video production method provided in this embodiment, the video producer firstly enters the text production node and input the object association information related to the video production object in text production node. Then the video producer may trigger the first trigger control and the second trigger control in sequence. The video related text related to the video production object may be generated. It may be noted that the whole process of the generation of the video related text is relatively intelligent and simple, reducing the time and labor cost invested by the text generation, and reducing the difficulty of generating the text content.

According to the video production method provided in this embodiment, a simple and easy-to-operate video production platform is provided for a video producer. The video production platform may present a text setup interface of the video to be produced. The text setup interface includes an information edit area, a first information display area, and a second information display area. Moreover, a function item for video text generation may be provided to the video producer. For the video producer, when video production is performed based on the video production method provided in this embodiment, the video producer firstly enters the text production node. Then, after input the object association information related to the video production object may be input in the text production node, the video producer triggers the first trigger control and the second trigger control in sequence. Thus, the video related text related to the video production object may be generated. Different from the conventional method that requires professional personnel to carry out text production, the whole process of video related text generation is relatively intelligent and simple. The knowledge requirements on professional video production knowledge of a video producer are not high. Moreover, the time and labor cost invested in text generation are reduced. The generation difficulty of text content is reduced. Furthermore, a foundation is provided for subsequent video production.

The technical solution of the embodiment of the present disclosure, by providing a method for video production provided, firstly, presenting a text setup interface in a displayed video producing window, the text setup interface comprising: an information edit area, a first information display area, and a second information display area; secondly, receiving a first trigger operation, wherein the first trigger operation triggers a first trigger control comprised in the information edit area after object association information of a video production object is inputted to an information edit box included in the information edit area; then, displaying object attribute information corresponding to the video production object in the first information display area, the object attribute information being determined based on the object association information; receiving a second trigger operation, where the second trigger operation triggers a second trigger control comprised in the first information display area; and finally displaying, in the second information display area, video related text corresponding to the video production object, the video related text being generated based on the object attribute information. The method for video production provided in the embodiment of the present disclosure provides a video producer with a simple and easy-to-operate video production platform, on which a text setup interface for the video to be produced may be presented, and the text setup interface includes an information edit area, a first information display area, and a second information display area, which can provide the video producer with functional items for generation of video text. For video producers, when producing video based on the method for video production provided by this embodiment, they first enter the text production node. At the text production node, after inputting the object-related information of the video production object, they can sequentially trigger the first trigger control and the second trigger control to generate the video related text corresponding to the video production object. Unlike the conventional solutions, where professional personnel are required for text production, the process of generating video related text in the above technical solution is more intelligent and simpler, requiring less professional knowledge for video production from the video producers, reducing the time and labor costs involved in text generation and reducing the difficulty of generating text content, providing a foundation for subsequent video production.

As a first optional embodiment of the present embodiment, on the basis of the above embodiment, the object association information may be optimized as the access link information of the video production object. For example, taking a certain shop as a video production object as an example, the access link information may be considered as accessing information page link information that are relied upon to access information pages containing information about the service of the shop to which the shop relates.

The first optional embodiment provides the underlying support for the video production process. After receiving the first trigger operation, the object attribute information corresponding to the video production object may be displayed in the first information display area in response to the first trigger operation because the underlying support is provided to generate the object attribute information based on the object association information.

Specifically, the step of determining the object attribute information based on the object association information may further include the following steps:

a1) access an information page associated with the video production object by the access link information, the information page including object service information of the video production object.

In this embodiment, the access link information is associated with an information page associated with the video production object. Each access link information corresponds to an information page related to a video production object included in the access link information. If the object association information input by the video producer in the information edit box is the access link information of the video production object, the information page associated with the video object at the rear end may be accessed through the access link information.

The information page associated with the video production object includes several pieces of information related to the video production object, including at least object service information of the video object. The object service information may be specifically object label information, object function description information, and object performance description information. Exemplarily, the object label information may include information related to a video production object name, a classification, and the like. The object function description information may include information describing a function of the video production object. The object performance description information may be performance effect information presented after the object has a function running. The information page associated with the video production may further include other information related to the video production object, which is not specifically limited in this embodiment.

b1) extract and parsing the object service information from the information page to obtain the object attribute information of the video production object.

After accessing the information page associated with the video production object as described above,, object service information such as object label information, object function description information, and object performance description information may be extracted from the information page. In this step, the object service information may be further parsed to obtain some key object attribute information of the video production object.

Exemplarily, assuming that the access link information for the video production object is the page link information of the information page covered by the relevant description of the store, the information page related to the shop may be accessed based on the page link information. The label information, the function description information, and the performance description information of the shop may be extracted from the information page. Then, the shop label information, the function description information, and the performance description information may be parsed to obtain information such as a commodity name, a commodity vendor, and a target consumption crowd of the commodity involved in the shop as object attribute information of the shop.

It should be noted that, in this embodiment, in addition to intelligently generating the object attribute information displayed in the first information display area based on the object association information, the first information display area further has an editable function. The video producer may perform secondary editing on the content in the first information display area, for example, editing operations such as adding, deleting, modifying, etc. The video producer may use the information obtained after the editing operation as the object attribute information.

The above technical solution of this embodiment specifies the step of generating object attribute information based on object association information. The information page associated with the video production object may be accessed through the access connection information. The related information may be extracted from the information page. The object attribute information of the video production object may be obtained through analysis. Moreover, a basis is provided for subsequent video related text generation.

As a second optional embodiment of the present embodiment, on the basis of the foregoing embodiment, the step of generating the video related text based on the object attribute information may further include the following steps:

a2) use the object attribute information as input data, or use the object attribute information and object context information extracted relative to the video production object from a data vector library as input data.

The second optional embodiment provides the underlying support for the video production process. The video related text corresponding to the video production object may be displayed in the second information display area in response to the trigger operation on the second trigger control because the underlying support is provided to generate the video related text based on the object attribute information.

In this embodiment, the video related text is generated by using an intelligent model, so the input data required by the intelligent model needs to be determined first. In this embodiment, two manners are provided for input data, and one way is to directly use the object attribute information as input data, and one way is to use object attribute information and object context information extracted from a relative video production object in the data vector library as input data.

It should be noted that, in this embodiment, the object related content of different video production object may be stored in advance through a database. The object related content may include some content in other aspects in addition to the service related information of the video production object, for example, generating context information of the video production object. In the video intelligent production implementation of this embodiment, object related content of the video object may be selected from the database for generating the required input data as the video related text. Considering that the data formats of the input data are different, the object related content stored in the database may be vectorization in advance. The database storing the content related to the vector format object formed after the quantization processing may become the data vector library.

In this embodiment, it may be considered that the data vector library includes more information related to video production object and wider scale. In order to ensure that the generated video related text is more accurate, it is also possible to consider more context information related to the video production object from the data vector library as the object context information. In the second manner, both the object attribute information and the context information are used as input data.

b2) input the input data into a trained text generation model, and determining output text description information as the video related text.

The text generation model may be specifically understood as a model for outputting the video related text based on the input data. The text generation model may be understood as a model generated in advance based on a large amount of data. The training dataset includes an input training set and a verification set. The input training set may be key information related to a video production object and the verification set is a text related to video production.

The video related text may be specifically understood as text required for subsequent video production. The video related text includes video title information, spoken text information related to the video, and video script description information. It should be known that the video related text may include one or more pieces of video title information and text content to be displayed in one or more videos. The text content may be playing text information or video script description information appearing in the video. In this embodiment, the video producer may select the matched video title information, the spoken text information, the video script description information, and the like from the generated video related text according to requirements of the video producer as the target text content used for subsequent video production.

Specifically, the input data is input into the text generation model to obtain an output result. The output result may be text description information. Then the text description information is used as the video related text.

The above technical solution specifies the step of generating video related text based on the object attribute information. The object attribute information or the object attribute information and the object context information extracted by the video production object may be used directly as input data. The input data may be input into a pre-trained model to obtain the desired video related text. Different from the conventional method need to invite professional video production personnel through professional video production software to participate in the production, the above technical solution realizes that the video related text required for subsequent video production may be obtained only based on the text generation model. The whole text generation process only needs the video producer to input the object association information of the video production object. The video related text may be obtained only by simply touching several control. Thus, the whole process of the video related text generation is relatively intelligent and simple. The requirement on the professional video production knowledge of the video producer is not high. The time and labor cost invested into the text generation are reduced. The generation difficulty of the text content is reduced. Moreover, a foundation is provided for subsequent video production.

As a third optional embodiment of the present embodiment, on the basis of the foregoing embodiment, the method may further include:

a3) in response to a trigger operation on a NEXT execution control in the text setup interface, switch the text setup interface to a material uploading interface.

In this embodiment, the production nodes included in the video production process include, in addition to the text production node, other production nodes. According to the process information of the video production process, the next production node of the text production node may be a material uploading node. In this step, the response to the trigger operation of the NEXT execution control in the text setup interface is entering the material uploading node from the text production node.

In an embodiment, when the video producer has completed the generation and display of the video related text in the text setup interface through the related operation, the video producer may trigger an operation on the NEXT execution control in the text setup interface. In this step, in response to the trigger operation on the NEXT execution control in the text setup interface, the video producer is analyzed to perform the operation of triggering the next production node. Thus the next production node, namely the material uploading node, after the text production node may be entered.

In this embodiment, the material uploading node is mainly configured to upload materials related to video production. Specifically, after entering the material uploading node in this step, a corresponding production interface may be presented in the video producing window. An interface displayed by the material uploading node is different from an interface displayed by the text making node. The manufacturing interface may be denoted as a material uploading interface. After entering the material uploading node, the text setup interface is switched to the material uploading interface corresponding to the material uploading node. The video producer may add and upload the material to be used through the material uploading interface.

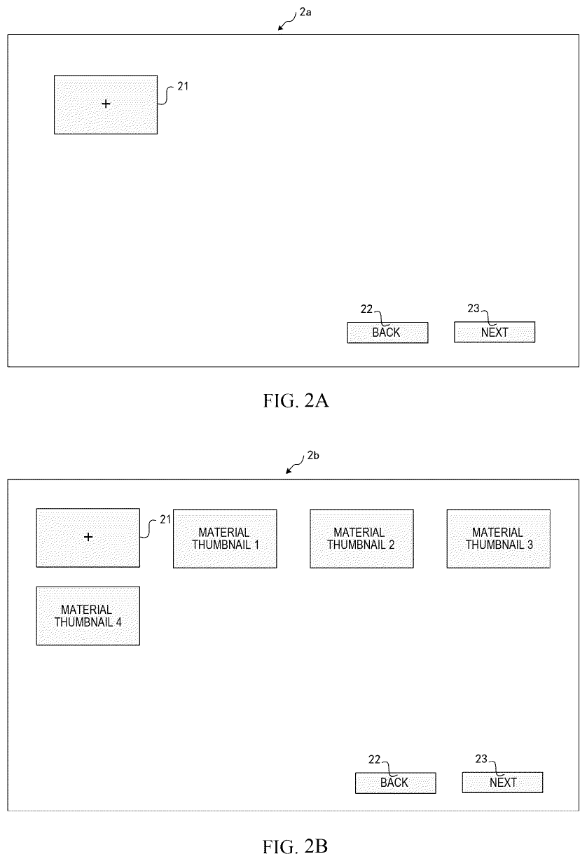

FIG. 2A gives an example diagram of a material uploading interface in an execution of a video production method according to this embodiment. Specifically, after a triggering operation of a control in a next step in a text setup interface, the material uploading interface 2a shown in FIG. 2A is presented. The material uploading interface 2a includes a material uploading control 21. The video producer may upload the material required for video production by clicking the material upload control 21. The material uploading interface 2a may further include a BACK execution control 22 and a NEXT execution control 23 (where both perform control may be presented in a button form in FIG. 2A).

Exemplarily, the material uploading interface may include a material uploaded control. a window may be popped up for setting a path for material uploading by clicking a control uploaded by the material. Moreover, a material to be uploaded may be selected.

b3) display a material thumbnail of an uploaded material file in the material uploading interface, the material file being associated with the video production object.

The material file may be understood as content presented in the video when the video is made. In this embodiment, the selected material file is associated with the video production object. The association may reflect that the material content included in the material file is mainly a video production object. The association may be an object panoramic material covering the video production object, a product material covering a service product involved in the video production object, or an effect display material that generates a performance effect on the video production object. For example, the material file may be a pre-shot video material, a picture material, or the like. The uploaded material file can be one or more, for the multiple material files can be considered to be the video production object from different angles, different directions or different scenes to take the material and the formation of a batch of material files.

Exemplarily, assuming that the hotpot shop is a video making object, and a video file with the hotpot shop as the main video content is to be made, the uploaded material file may be a plurality of files including contents such as a shop sign, a surrounding environment, an in-store environment, dishes, and a visiting place of the in-store customer.

FIG. 2B gives a further example diagram of the material uploading interface in the method for video production provided by the embodiment. Specifically, after the video producer uploads the material, the material thumbnail of the uploaded material file is displayed in the material uploading interface 2b. The material thumbnail uploaded in FIG. 2B has the material thumbnail 1, the material thumbnail 2, the material thumbnail 3, and the material thumbnail 4.

In this embodiment, the video producer may select which material files to upload according to their own requirements. After the material file is uploaded, the thumbnail of the uploaded material file may be displayed in the material uploading interface, denoted as a material thumbnail. It should be noted that, the material thumbnail may be a material picture, or a video material file with a plurality of video covers as a presentation picture. The material upload interface has a function of previewing the presented material image or the video material file. When the preview of the video material file is performed, it may be implemented by triggering a video cover image presented by the video material file.

It may be seen that, for the material uploading node, the video producer only needs to select the corresponding material file for uploading. The operation is intelligent and simple. The professional knowledge of excessive video production is not needed for the completion of this step. The manpower and time cost is saved. The operation difficulty is reduced.

The above technical solution specifies the description of the execution logic for moving from the text production node to the next production node (i.e., the material upload node) in accordance with the video production process. After the text production node realizes the video related text generation, the material uploading interface may be specifically presented by triggering the NEXT execution control in the text setup interface. The uploading of the material file required for video production in the material uploading interface is carried out. Moreover, a foundation is provided for subsequent video production.

On the basis of the third optional embodiment, the method may further include:

a4) in response to a trigger operation on a BACK execution control in the material uploading interface, switch from the material uploading interface to the text setup interface to display.

Considering that each video production process is performed in sequence, the present embodiment further includes a function of rolling back from the current production interface to the previous production node. A BACK execution control is set in the material uploading interface. The triggering operation of the control is executed on the previous step. The control may be rolled back to the text manufacturing node. The material uploading interface is switched to the text setup interface for display to realize the fallback of the manufacturing node. Specifically, after the video producer performs the trigger operation on the BACK execution control in the material uploading interface, this step returns to the text production node in response to the trigger operation of the BACK execution control in the material uploading interface. When fallback to the text making node, the corresponding interface is also switched to the text setup interface and displayed. After being back to the text making node, the content in the text setup interface may be edited and modified.

With continued reference to FIG. 2B, the material uploading interface 2b may further include a BACK execution control 22 (presented in a button form in the figure). Moreover, the material uploading interface 2b may be switched to the text setup interface again and displayed by triggering the BACK execution control 22.

b4) in response to a trigger operation on a NEXT execution control in the material uploading interface, switching the material uploading interface to a video preview interface, and displaying a generated video file in the video preview interface, wherein the video file is generated based on the uploaded material file and is associated with the video production object.

In this embodiment, the manufacturing node in the video production process includes a text production node, a material uploading node, and a video preview node. Each production node included in the video production process is set according to the execution sequence. The video preview node is set as the next process node after the material uploading node in the video production process.

Considering that each video production process is executed in sequence, the present embodiment further provides a function of entering the next video production process from the current video production process. A NEXT execution control is set in the material uploading interface. By triggering the NEXT execution control, a next production node may be entered. A node sequence is made according to the video production process. The next production node may be or similar as a video preview node. A production interface corresponding to the video preview node may be recorded as a video preview interface.

In this embodiment, the video preview interface corresponding to the video preview node is mainly used to display a preview of the generated video file. Specifically, in this step, the interface displayed by the video preview node and the interface displayed by the material uploading node are distinguished in response to the trigger operation of the NEXT execution control in the material uploading interface. After entering the video preview node, the material uploading interface is switched to the video preview interface corresponding to the video preview node.

For example, with continued reference to FIG. 2B, the material uploading interface 2b may further include a NEXT execution control 23, which may be switched to the video preview interface and displayed by triggering the NEXT execution control 23.

In this embodiment, the generated video is presented in the form of a video file in the video preview interface. It should be known that the video file is generated based on the video related text and the uploaded material file. The generated video file is associated with the video production object. The association relationship may be considered that the video content of the generated video file includes the display of the video production object. The association relationship may be directly displaying the video production object itself, or display of service content related to the video production object.

It should be noted that, there may be one material file uploaded. For a case in which the uploaded material file is one, the material file and the video related text may be directly fused. If the uploaded material file is a plurality of cases, the uploaded material file needs to be divided, cropped, spliced. and the like to obtain the synthesized content. Then the synthesized content is fused with the video related text. For both cases, the video effect may be set for the content after the fusion processing. Then, the video file is obtained, and the video file is displayed in the video preview interface.

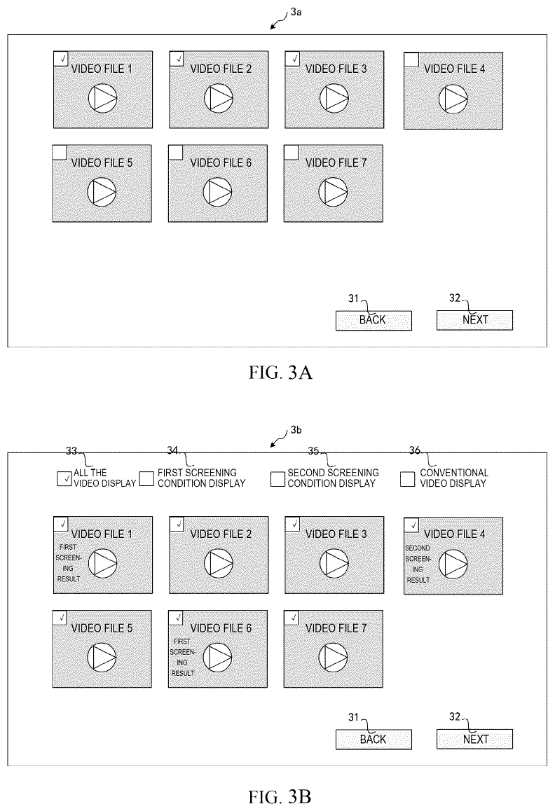

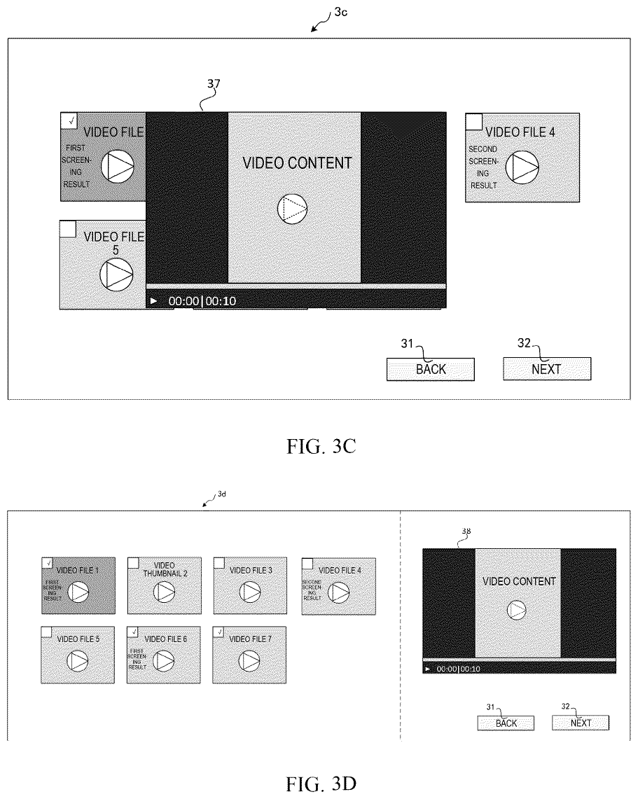

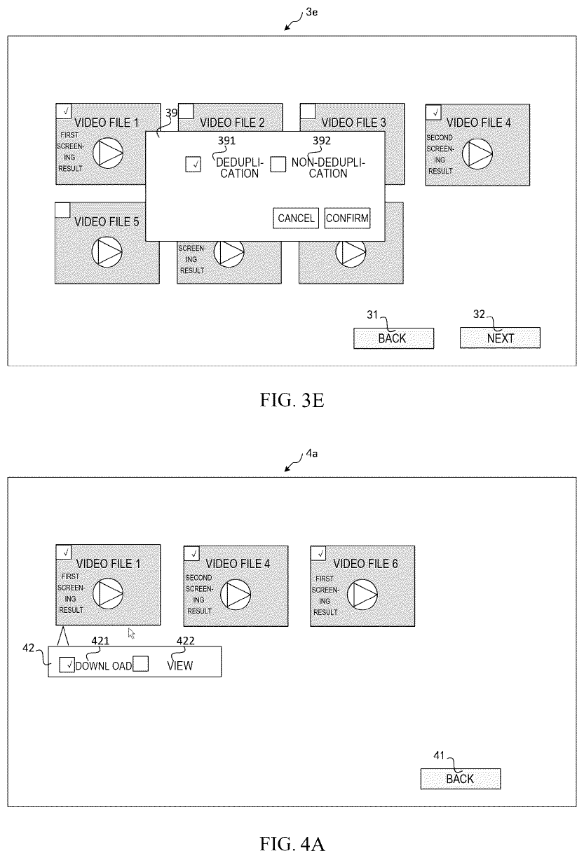

FIG. 3A gives an example diagram of a video preview interface in an execution of a method for video production according to this embodiment. Specifically, after a trigger operation of a control in a material uploading interface is performed, a video preview interface 3a shown in FIG. 3A is presented. A generated video file, such as a video file 1, a video file 2, a video file 3, a video file 4, a video file 5, a video file 6, and a video file 7, is displayed in the video preview interface 3a. In addition, for ease of operation, a check box for checking a video file may be presented in each video file, for example, the video file 1, the video file 2, and the video file 3. These video files are checked in FIG. 3A. The video preview interface 3a may further include a BACK execution control 31 and a NEXT execution control 32 (the presentation of the control in a button form).

The above technical solution specifies the description of the execution logic for moving from the material upload node to the next production node (i.e., the video preview node) in accordance with the video production process. After the material uploading node realizes the uploading and displaying of the material file, the video preview interface may be specifically presented by triggering the NEXT execution control in the material uploading interface. The generated video file is displayed in the video preview interface. The video producer only needs to trigger the NEXT execution control in the material uploading interface to realize video synthesis. The operation is smart and simple, and does not require too much expertise in video production to complete this step, which saves labor and time costs and reduces the difficulty of operation.

The following may be considered as an underlying technical support for generating a video file based on an uploaded material file. As a specific implementation, the step of generating the video file based on the uploaded material file includes:

When the number of uploaded material files is 1, the material file is fused with the video related text. According to the pre-configured video production attribute information, enhancement processing is performed on the content to be displayed of the generated fusion video to obtain the video file formed after the enhancement processing.

In this embodiment, when the number of uploaded material files is 1, the material file and the video related text may be directly fused to generate the video file. In the implementation of the fusion processing of the material file and the video related text, firstly, it is ensured that the uploaded material file is a file in a video format. Then, the previously generated video related text may be fused into the material file in the video format. The specific display time, or the display position and the display form of the video related text in the material file may be configured in the fusion processing logic. Thus, the video file formed by fusing can not only include the video picture but also the text content displayed on the video picture.

It may be understood that the video file formed by fusing the material file and the video related text may be considered as a video file manufactured by the method provided in this embodiment. In this embodiment, in order to enable the generated video file to have a more optimized display effect to improve the visual effect, the fused video may be denoted as a fused video. Moreover, the display effect of the video to be displayed of the fused video is further enhanced.

Specifically, the enhancement processing of the display effect may be implemented by processing the fused video according to pre-configured video production attribute information. The video production attribute information may be specifically understood as the attribute information related to the video presentation set for ensuring the display effect of the video in the video production. The video production attribute information may be pre-configured or obtained by the video producer based on the video production requirement, or may be generated according to a set intelligent configuration policy.

In this embodiment, the video production attribute information may include attribute configuration information of a display effect such as a video cover, a video background music, a video transition form, a filter, and a flower word when the video is displayed. After obtaining the video production attribute information, the display effect of the to-be-presented content of the fused video may be configured according to the configuration content included in the video production attribute information. For example, a video cover matching the fused video may be determined according to the video cover configuration information. For example, an enhancement of the transfer effect may be performed on the fused video by using a transition form corresponding to the video transition configuration information. For another example, an enhancement of the video filter effect may be performed on the fused video in the form of a filter corresponding to the path configuration information.

It should be noted that the video production attribute information in this embodiment includes, but is not limited to, the attribute configuration information used to enhance the display effect. Similarly, the display effect that may be achieved after the fused video is processed based on the video production attribute information is not limited to the foregoing description.

The above technical solution specifies the step of generating a video file based on the uploaded material file when the number of uploaded material files is 1. The material file and the video related text are fused through the bottom layer support. The video file may be formed in combination with the video production attribute information.

The following may be considered as an underlying technical support for generating a video file based on an uploaded material file. As a specific implementation, the step of generating the video file based on the uploaded material file includes:

a5) in response to that there are at least two uploaded material files, parse the uploaded material files and obtain predetermined synthesis video configuration information.

In this embodiment, when there are at least two uploaded material files, video synthesis needs to be involved. The configuration information related to the synthesized video is recorded as synthetic video configuration information. Exemplarily, the synthesis video configuration information may be information such as a quantity of material files to be used, a video making mode setting item, and a material extraction duration setting item, whether the synthesized video is a fixed duration, a quantity of videos to be synthesized, a length of each synthesized video, and the like.

Specifically, the uploaded material file is parsed. The predetermined synthetic video configuration information is acquired.

b5) divide and crop the uploaded material file according to a material analysis result to form a plurality of material segments corresponding to the material file, and selecting material segments from different material files for material content splicing according to the synthesis video configuration information to generate a plurality of synthesized videos.

In this embodiment, the uploaded material file is parsed to obtain a material analysis result. For example, the material analysis result may be classifying the same type of material file. Moreover, the material file of the external environment may be classified into one type. The material file of the internal environment may be classified into one type. Then dividing, cropping, etc. are performed on the material file included in each type. Alternatively, a plurality of material files are extracted from each type of material file for processing.

Specifically, the uploaded material file is divided and cropped according to the material analysis result to form a plurality of material segments corresponding to the material file. The material content splicing is performed on the material segments from different material files according to the synthetic video configuration information, so as to generate a plurality of synthetic videos.

c5) perform a fusion processing on the video related text and different synthesized videos respectively, and performing enhancement processing on video content of a generated fused video to be displayed according to pre-configured video production attribute information to obtain a video file formed after enhancement processing.

After the plurality of synthesized videos are obtained, the video related text and the different synthesized videos are respectively fused. Then, the generated enhanced processing of the to-be-displayed content may be performed on each generated fused video. The fusion processing of the video related text and different synthetized videos is similar to the implementation process when the material file is 1, and details are not described herein again.

In this embodiment, a process of performing display effect enhancement processing on different fusion videos is similar to an implementation process when the material file is 1, and details are not described herein again. In a word, through the video production attribute information, the matched display effect enhanced attribute configuration information may be determined for each fused video according to the intelligent matching strategy. Thus the video file with different enhancement effects may be obtained after the fused video is enhanced.

The above technical solution specifies the step of generating a video file based on the uploaded material files when the number of uploaded material files is at least two. The material file is parsed through the bottom layer support. The synthesized video configuration information is divided, cropped and spliced. A synthesized video is generated. The synthesized video is fused with the video related text. The video file may be formed in combination with the video production attribute information.

Based on the above third optional embodiment, the video preview interface may be optimized to include a display type selection box, and the display type selection box includes: all video display items, a first screening condition display item, a second screening condition display item, and a conventional video display item.

In this embodiment, the video preview interface includes a display type selection box. By triggering the different display items included in the display type selection box, display of which video files are specifically performed may be determined in the video preview interface. The display type selection box may include all video display items, a first screening condition display item, a second screening condition display item, and a conventional video display item.

As a specific implementation, the video file generated in the video preview interface may be optimized as the following steps:

a6) display all generated video files in the video preview interface by using the all video display item as a default display type, presenting a first screening result label on a first video file satisfying the first screening condition, and presenting a second screening result label on a second video file satisfying the second screening condition.

In this embodiment, a default display type may be set, where all the video display items are used as default display types. When triggering of other display items is not performed, all the generated video files may be displayed in the video preview interface. The video file may be presented in a form of presenting a corresponding video cover.

It should be clear that, in all video files shown, for a video file meeting a first screening condition, a first screening result label may be displayed on the video file. Moreover, for a video file meeting a second screening condition, a second screening result label may be displayed on the video file. The first screening condition and the screening content for screening included in the second screening condition are different.

In this embodiment, the generated video file is mainly obtained by material synthesis between one or more material files. Thus, for each video file, it can determine which material files the video file contains. In this embodiment, the display of the video file may be screened according to the material file source situation of the material file contained in the video file.

In this embodiment, the setting of the first screening condition and the setting of the second screening condition is not specifically limited. The first screening condition and the second screening condition may be divided based on the repetition rate of the video content in the video file. For example, the first screening condition may be a screening condition with a very low repetition rate. The second screening condition may be a screening condition with a low repetition rate. Whether the video file meets the first screening condition and the second screening condition may be determined based on one of the followings: whether the material file included in the material file source participates in other video file generation or not. whether the included material file participates in other video file generation, how many material files participate in other video file generation to determine. For example, for a video file, if none of material files contained in the material file source participates in generation of a further video file, it is determined that the video file satisfies the first screening condition. If a number of material files, which participates in generation of the further video file and belongs to material files comprised in the material file source, is less than a predetermined number, it is determined that the video file satisfies the second screening condition.

In this embodiment, it may also be determined whether the screening condition is satisfied based on the material similarity value possessed by the material file itself. It may be considered that after the material file is uploaded, the similarity of the material content included in the material file may be calculated to obtain the material similarity value. The generated video file is mainly obtained by material synthesis between one or more material files. Thus, for each video file, it can determine which material files the video file contains, the similarity of the video file may be determined according to the material similarity of the material files contained in the video file. The display of the video file is screened based on the similarity of the video file.

For example, the first screening condition may be a screening condition with a very low repetition rate, and the second screening condition may be a screening condition with a low repetition rate. Whether the video file satisfies the first screening condition and the second screening condition may be determined based on the video similarity between the video file and a predetermined similarity threshold. For example, if the video similarity is lower than a first similarity threshold, the video file is determined as satisfying a first screening condition. If the video similarity is greater than or equal to a first similarity threshold and less than a second similarity threshold, the video file is determined as satisfying a second screening condition. The first similarity threshold is less than a second similarity threshold.

Specifically, after the entire video file is generated, the video file may be analyzed to determine the video file that satisfies the first screening condition and the video file that satisfies the second screening condition. The video file satisfying the first screening condition is determined as the first video file from the video file. The video file meeting the second screening condition is determined as the second video file. When the video file of all the video files is displayed on the video preview interface, the first screening result label is presented on the first video file conforming to the first screening condition. The second screening result label is presented on the second video file conforming to the second screening condition. The video producer can more intuitively know the condition of each video file by marking the result label in the video file.

b6) in response to a trigger operation on the first screening condition display item, determine the first video file satisfying the first screening condition from all of the generated video files, and display the first video file in the video preview interface in a form of carrying the first screening result label.

Specifically, if the video producer only wants to display the video file conforming to the first screening condition, the video producer may trigger the first screening condition display item. For example, the first screening condition may be triggered by checking the first screening condition display item. In this step, in response to the trigger operation on the first screening condition display item, the video file satisfying the first screening condition is determined from all the video files as the first video file. The first video file may be displayed in the video preview interface. The first video file may carry the first screening result label.

c6) in response to a trigger operation on the second screening condition display item, determine the second video file satisfying the second screening condition from all of the generated video files, and display the second video file in the video preview interface in a form of carrying the second screening result label.

Specifically, if the video producer only wants to display the video file conforming to the second screening condition, the video producer may trigger the second screening condition display item. In this step, the video file satisfying the second screening condition is determined from all the video files in response to the trigger operation on the second screening condition display item as the second video file. The second video file may be displayed in the video preview interface. The second video file may carry the second screening result label.

d6) in response to a trigger operation on the conventional video display item, display other video files than the first video file and the second video file in all of the generated video files in the video preview interface.

Specifically, if the video producer only wants to display the video file of the regular video and does not display the first video file and the second video file, the video producer may trigger the conventional video display item. In this step, other video files other than the first video file and the second video file are determined from the video files of all the video files in response to the trigger operation on the conventional video display item. And other video files may be displayed in the video preview interface.

FIG. 3B gives a further example diagram of a video preview interface in an execution of a video manufacturing method according to this embodiment. Specifically, after a trigger operation of a control in a material uploading interface is triggered, the video preview interface 3b shown in FIG. 3B is presented. The video preview interface 3includes all the video display item button 33, the first screening condition display item 34, the second screening condition display item 35, and the conventional video display item 36. The video file corresponding to the display item. The first screening result label is presented on the first video file conforming to the first screening condition. The first screening result label is presented on the second video file conforming to the second screening condition. It can be seen that the video file includes a video file 1, a video file 2, a video file 3, a video file 4, a video file 5, a video file 6, and a video file 7, where a first screening result label is presented in the video file 1 and the video file 6, and a second screening result label is presented in the video file 4. When all the display items are checked, all the generated video files are displayed in the video preview interface. When the first screening condition display item 34 is checked, only the video file 1 and the video file 6 are displayed in the video preview interface. When the second screening condition display item 35 is checked, only the video file 4 is displayed in the video preview interface. When the conventional video display item 36 is checked, only the video files 2, 3, 5, and 7 are displayed in the video preview interface.

The above technical solution specifies the triggering operation through different types of video display items. The video file corresponding to the video display item type may be displayed in the video preview interface. The video file to be displayed may be selected based on the demand of the video producer.

As a specific implementation, the step of determining the first video file and the second video file in the generated video file may be refined to include the following steps:

a7) analyze, for each of the generated video file, a material file source corresponding to video content in the video file.

As a specific implementation, the underlying support determined for the first video file and the second video file is implemented. The generated video file is mainly obtained by material synthesis between one or more material files. Thus, for each video file, it is possible to determine which material files the video file contains. In this embodiment, the display of the video file may be screened according to the material file source situation of the material file contained in the video file.

Specifically, for each generated video file, the material file corresponding to the video content in the video file may be analyzed. The material file corresponding to the video content may be denoted as a material file source.

b7) if none of material files contained in the material file source participates in generation of a further video file, determine the video file as the first video file satisfying the first screening condition.

Specifically, if none of the material files included in the material file source participates in other video file generation, the corresponding video file is determined as the video file satisfying the first screening condition. The corresponding video file is denoted as the first video file. It may be considered that the first video file is a video file with a very low repetition rate with other video files.

c7) if a number of material files, which participates in generation of the further video file and belongs to material files comprised in the material file source, is less than a predetermined number, determine the video file as the second video file satisfying the second screening condition.

The predetermined number may be determined according to an empirical value. Specifically, if a number of material files, which participates in generation of the further video file and belongs to material files comprised in the material file source, the corresponding video file is determined as the video file satisfying the second screening condition. Moreover, the corresponding video file is denoted as the second video file. It may be considered that the second video file is a video file with a lower repetition rate than other video files. The repetition rate of the first video file is lower than the repetition rate of the second video file.

The above technical solution specifies an implementation of the determination of the first video file and the second video file for the generated video file. The low-repetition rate video is determined through the material file source. The low-repetition rate video is used as the bottom layer support for determining the first screening condition video and the second screening condition video. A basis is provided for marking the first screening result label and the second screening result label in the video file.

On the basis of the third optional embodiment, as another specific implementation, the step of determining the first video file and the second video file in the generated video file may be further refined into the following steps:

a8) obtain a material similarity value that the uploaded material file has, the material similarity value being determined by performing similarity calculation on the comprised material content after the material file is uploaded.

As another determination manner of the first video file and the second video file, it is determined based on the material file itself. The generated video file is mainly obtained by material synthesis between one or more material files. Thus, for each video file, it is possible to determine which material files the video file contains. In this embodiment it is possible to determine the similarity of the video file according to the material similarity of the material files contained in the video file. It may be considered that the material similarity value is determined by performing similarity calculation on the material content included after the material file is uploaded. This step is used to obtain the material similarity value possessed by the uploaded material file.

b8) determine, for each of the generated video files, a target material file composing the video content in the video file.

Specifically, for each generated video file, a material file constituting the video content in the video file is determined as the target material file.

c8) determine a video similarity of the video file by performing weighted calculation on the material similarity values of the target material file.

After the material file is uploaded, the material similarity value of the material file is calculated. After the target material file constituting the video content in the video file is determined, the material similarity of each target material file may be obtained. The material similarity value of the target material file is weighted and calculated, so as to determine the similarity of the video file as the video similarity. For example, assuming that the target material file that constitutes the video content in the video file is three, the weight of each target material file may be set to ⅓. The material similarity value of each target material file is multiplied by ⅓. The obtained results are added to obtain the video similarity of the video file.

d8) in response to that the video similarity is less than a first similarity threshold, determine the video file as the first video file satisfying the first screening condition.

In this embodiment, the first similarity threshold and the second similarity threshold are predetermined similarity thresholds, respectively. The first similarity threshold is less than the second similarity threshold. The first similarity threshold and the second similarity threshold may be determined according to actual conditions.

Specifically, if the video similarity is lower than the first similarity threshold, the video file may be determined as the video file meeting the first screening condition and recorded as the first video file. It may be considered that the first video file is a video file with a very low repetition rate with other video files.

e8) in response to that the video similarity is greater than or equal to the first similarity threshold and less than a second similarity threshold, determine the video file as the second video file satisfying the second screening condition.

Specifically, if the video similarity is greater than or equal to the first similarity threshold and less than the second similarity threshold. The video file is determined as the video file satisfying the second screening condition. Moreover, the video file is denoted as the second video file. It may be considered that the second video file is a video file with a lower repetition rate than other video files. The repetition rate of the first video file is lower than the repetition rate of the second video file.

The above technical solution specifies another implementation of the determination of the first video file and the second video file for the generated video file. Determining a low repetition rate video by a clip similarity value of a clip file serves as the underlying support for determining the first video file and the second video file. A basis for labeling the video file with the first screening result label and the second screening result label is provided.

On the basis of the third optional embodiment, the following describes two manners of playing video content.

a9) in response to a playback trigger operation for any of displayed video files, perform video content playback of a corresponding video file in a pop-up video preview playback window, wherein the video preview playback window is presented in a created layer, and the layer is above a layer where the video preview interface is located.

As a video content playing manner, the video producer may perform a playing triggering operation on any video file displayed. Correspondingly, in this step, the video preview playback window is popped up in response to the playback trigger operation on the displayed any video file. The layer where the video preview playback window is located is another layer different from the layer where the video preview interface is located. The layer of the video preview playback window is located on the layer where the video preview interface is located. The video content of the corresponding video file is further played in the pop-up video preview playback window.

As shown in FIG. 3C, when the video file 1 is desired to be played, the video file 1 is triggered to pop up the video preview playback window 37. The video preview playback window is presented in the created layer. The layer is located on the layer where the video preview interface 3c is located. The video content of the corresponding video file is played in the pop-up video preview playback window.

b9) or, in response to the playback triggering operation for any of displayed video files, expand a preview playback area in a converged state in the video preview interface, and display video content of the corresponding video file in the preview display area, wherein the preview playback area enters the convergence state after completion of the playing of the video file, and the display area size for displaying the video file is adjusted according to expansion or convergence of the preview playback area.

Different from that the video preview playback window and the video preview interface belong to different layers. In this step, the preview playing area is included in the video preview interface. When no video is played, the preview playing area is in a converged state. As another video content playing manner, the video producer may perform a playing triggering operation on any displayed video file. Correspondingly, in this step, in response to the playback trigger operation on the displayed any video file, the preview playing area in the converged state is expanded in the video preview interface,. The video content of the corresponding video file is played in the preview display area.

It should be noted that, after the video file is played, the preview playing area enters the convergence state. In addition, since the display area and the preview playback area of the video file display are both within the video preview interface. The expansion or convergence of the preview playback area affects the display area size of the video file presentation. For example, after the preview playback area is expanded, the display area displayed by the video file becomes smaller. After the preview playback area converges, the display area displayed by the video file becomes larger.

FIG. 3D gives a further example diagram of a video preview interface in an method of video production according to this embodiment. As shown in FIG. 3D, when a video file 1 is desired to be played, a preview playback area 38 in a converged state is expanded within the video preview interface. Video content playback of a corresponding video file is performed in the preview display area.

The above technical solution adds a video content playback function, which can be performed in two different ways by triggering operations on the video file.

As a fourth optional embodiment of the present embodiment, on the basis of the foregoing embodiment, the method may further include:

a10) in response to a trigger operation on a BACK execution control in the video preview interface, switch from the video preview interface to the material uploading interface for display.

Considering that each video production process is performed in sequence, the present embodiment further includes a function of rolling back from the current production interface to the previous production node. A BACK execution control is set in the video preview interface. The trigger operation of the control is executed on the previous step. The control may be rolled back to the material uploading node. The video preview interface is switched to the material uploading interface for display to realize the fallback of the production node. Specifically, after the video producer performs the trigger operation on the BACK execution control in the video preview interface, this step returns to the material uploading node in response to the trigger operation of the BACK execution control in the video preview interface. When rolling back to the material uploading node, the corresponding interface is also switched to the material uploading interface and displayed. After being rolled back to the material uploading node, the material file may be uploaded again in the material interface.

With continued reference to FIG. 3D, the video preview interface may further include a BACK execution control 31 (presented in a button form). The video preview interface may be switched to the material uploading interface again and displayed by triggering the BACK execution control 31.

b10) in response to a trigger operation on a NEXT execution control in the video preview interface, switch the video preview interface to a video export interface, and displaying a selected video file as a to-be-exported video file in the video export interface.

The selected video file is selected in advance from a video file displayed on the video preview interface.

In this embodiment, the production node in the video production process includes a text production node, a material uploading node, a video preview node, and a video exporting node. Each production node included in the video production process is set according to an execution order. The video export node is set as the next process node after the video preview node in the video production process.

Considering that each video production process is executed in sequence, the present embodiment further provides a function of entering the next video production process from the current video production process. A NEXT execution control is set in the video preview interface, a trigger operation of the control is executed on the next step. A next production node may be entered. A node sequence is produced in the video production process. The next production node may be or similar as a video export node. A production interface corresponding to the video export node may be recorded as a video export interface.

In this embodiment, the video producer may select a video file to be exported from the video file displayed on the video preview interface according to requirements. Moreover, the video file may be denoted as the selected video file. For example, the video producer may select the corresponding video file by checking the check box of the video file that wants to export. In this step, the selected video file is selected from the displayed video file. The selected video file is used as the to-be-exported video file. Moreover, the selected video file is displayed on the video exporting interface.

For example, with continued reference to FIG. 3D, the video preview interface may further include a NEXT execution control 32 (presented in a button form), and may be switched to the video export interface and displayed by triggering the NEXT execution control 32.

The above technical solution specifies the description of the execution logic for moving from the video preview node to the next production node (i.e., the video export node) in accordance with the video production process. After the video preview node realizes the display of the video file, the video export interface may be specifically presented by triggering the NEXT execution control in the video preview interface. The video export node is exported to realize complete production of the video.

Further, before switching the video preview interface to the video export interface, the method may further include:

a11) pop out a video deduplication configuration window, the video deduplication configuration window comprising: a deduplication option and a non-deduplication option.

In this embodiment, a deduplication function is added. Specifically, before switching the video preview interface to the video export interface, in other word, before entering the video export node, the video de-emphasis configuration window may be triggered. The video deduplication configuration window includes a deduplication option and a non-deduplication option. The deduplication option is used by the video producer to perform deduplication operation on the selected video file. The non-deduplication option indicates that the selected video file does not need to be deduplicated.

b11) in response to receiving a select operation on the deduplication option, deduplicate the selected video file, and reserving the deduplicated selected video file.

Specifically, if the video producer wants to perform video export based on the deduplicated video file, the deduplication option may be selected. Correspondingly, if the selected operation on the deduplication option is received, the selected video file may be deduplicated. The deduplicated selected video file may be retained. It may also be understood that the video file with the first screening result label and the second screening result label in the selected video file is retained. Other video files are screened out as a video file with a high repetition rate.

c11) in response to receiving a select operation on the non-deduplication option, reserve all selected video files.

Specifically, if the video producer wants to perform video export on the selected video file, the non-deduplication option may be selected. Accordingly, if a selected operation for non-deduplication is received, all selected video files may be retained.

As shown in FIG. 3E, before the video preview interface is switched to the video export interface, the video deduplication configuration window 39 is popped up. The video deduplication configuration window includes a deduplication option 391 and a non-deduplication option 392. The deduplication configuration window further includes CANCEL and CONFIRM. The video preview interface includes a BACK execution control 31 and a NEXT execution control 32 (where both execution control may be presented in a button form in FIG. 3E).

According to the technical scheme, the function of de-duplicating the selected video file is added. The deduplication or reservation of the selected video file may be realized by deduplicating the deduplication option and the non-deduplication option in the video configuration deduplication window.

Further, a hidden operation bar may also be set on the video file to be exported. The method may be optimized to include:

A12) in response to detecting a hover event on any of to-be-exported video files, display a corresponding hidden operation bar, the hidden operation bar comprising a video download item and a video view item.

In this embodiment, each to-be-exported video file has a hidden operation bar. When no hover event exists on the to-be-exported video file, the operation bar is hidden. When it is detected that a hover event exists on any video file to be exported, a corresponding hidden operation bar is displayed. For example, when the video producer moves the mouse cursor to the to-be-exported video file, a corresponding hidden operation bar is displayed. A hidden operation bar may be provided with some function items, such as video download items, video viewing items, and the like. The video producer may select a function item on the hidden operation bar to perform a corresponding function.

b12) in response to a select operation on the video download item, store the to-be-exported video file according to a set storage path.

In this embodiment, after the video producer selects the video download item, this step is used to store the to-be-exported video file according to the set storage path in response to the selected operation on the video download item. The storage path may be a storage path selected by the video producer, or may be a predetermined default storage path.

c12) in response to a select operation on the video view item, play video content of the to-be-exported video file in a pop-up video playback window.

In this embodiment, when the video producer selects the video viewing item. This step is used to pop up the video playing window in response to the selected operation on the video viewing item. Moreover, the video content of the video file to be exported may be played in the video playing window.

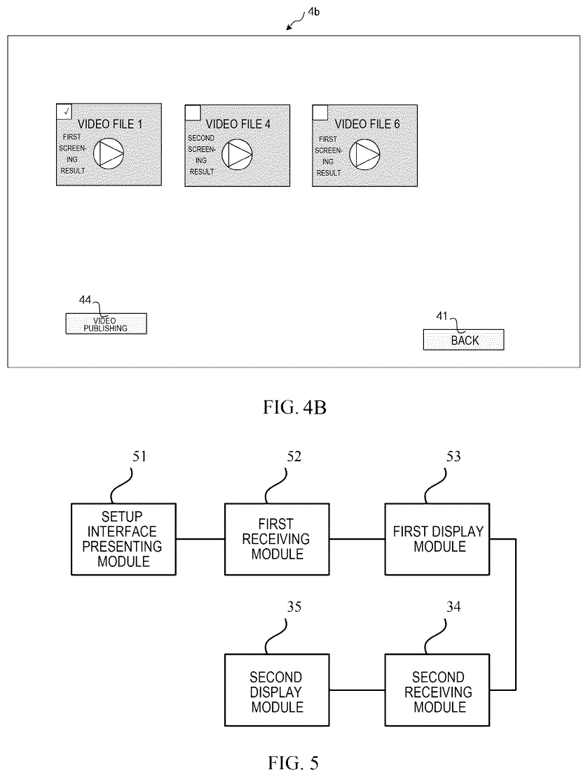

FIG. 4A gives an example diagram of a video export interface in the execution of a video production method according to this embodiment. As shown in FIG. 4A, when it is monitored that a mouse hovers on a video file, a corresponding hidden operation bar 42 is displayed. The hidden operation bar 42 includes a video download item 421 and a video view item 422. Export of the to-be-exported video file may be implemented by performing a selected operation on the video download item 421. The video content of the to-be-exported video file may be played through a selected operation on the video view item 422.

According to the technical scheme, the function of video downloading and viewing is increased. The downloading and viewing of the video may be realized by selecting the video downloading item or the video viewing item in the hiding operation bar.

As a fifth optional embodiment of the present embodiment, on the basis of the above embodiment, the method may further include:

A13) in response to a trigger operation on a video publishing control, present the video publishing control in the video preview interface.

In this embodiment, the function of video publishing is also increased. Specifically, the video preview interface further includes a video publishing control. When the video producer wants to publish the completed video, the video publishing control may be triggered. When a video producer has a video publishing requirement, a to-be-published file may be selected from the displayed video file. Moreover, the to-be-published file is denoted as a selected video file. After the video file to be published is selected, the video producer may trigger the video publishing control, in response to the triggering operation of the video publishing control, in this step.

b13) obtain a selected video file selected from presented video files, and publish the selected video file as a video publishing file.

In this step, a selected video file selected by a video producer is selected from the displayed video file, and the selected video file is published as a video publishing file.

FIG. 4B gives a further example diagram of a video export interface in an method for video production according to this embodiment. As shown in FIG. 4B, a video publishing control 44 (presenting a control in a button form) is provided on the video exporting interface 4b. Publishing of a video file corresponding to the selected video file may be implemented by triggering the video publishing control 44.

According to the technical scheme, the video publishing function is improved. The selected video file may be published by triggering the video publishing control.

Based on the above fifth optional embodiment, the method may further include:

a14) aggregate playback effect description data generated after publishing the video publishing file.

In this embodiment, after the video publishing file is published, the data related to the playing effect may be recorded as the playing effect description data. For example, the playback effect description data may be data such as an audience, an amount of play of the published video file, and feedback on the playback effect of the audience, such as a like, a comment, or the like. Specifically, after the video publishing file is published, the generated playing effect description data is aggregated.

b14) update a processing policy involved in video file generation according to the playback effect description data.

In this embodiment, the processing policy involved in generating the video file is updated based on the playback effect description data. For example, the playback effect description data is used as training data of the text generation model. The text generation model is generated based on the playback effect description data.

According to the technical scheme, the steps of updating the processing strategy based on the playing effect description data are added. A basis is provided for subsequent generation of more accurate videos.

It may be seen that the whole video production is intelligent, concise and streamlined. The video production may be completed only according to the prompt of each node, the video production process is simplified to a great extent. The video content generation difficulty and cost input are reduced by adopting the video production method.

FIG. 5 is a schematic structural diagram of an apparatus for video production according to an embodiment of the present disclosure. As shown in FIG. 5, the apparatus includes: a setup interface presenting module 51, a first receiving module 52, a first display module 53, a second receiving module 34, a second display module 35.

The setup interface presenting module configured to present a text setup interface in a displayed video producing window, the text setup interface comprising: an information edit area, a first information display area, and a second information display area.

The first receiving module is configured to receive a first trigger operation, wherein the first trigger operation triggers a first trigger control comprised in the information edit area after object association information of a video production object is inputted to an information edit box included in the information edit area.

The first display module is configured to display object attribute information corresponding to the video production object in the first information display area, the object attribute information being determined based on the object association information.

The second receiving module is configured to receive a second trigger operation, wherein the second trigger operation triggers a second trigger control comprised in the first information display area; and

The second display module is configured to display, in the second information display area, video related text corresponding to the video production object, the video related text being generated based on the object attribute information.

The apparatus for video production provided by the embodiment of the disclosure provides a video production platform which is simple and easy to operate for a video producer. The text setup interface of the video to be produced may be presented on the video production platform. The text setup interface comprises an information edit area, a first information display area and a second information display area. The function item for video text generation may be provided for the video producer. For video producers, when producing video based on the method for video production provided by this embodiment, they first enter the text production node. At the text production node, after inputting the object-related information of the video production object, they can sequentially trigger the first trigger control and the second trigger control to generate the video related text corresponding to the video production object. Unlike the conventional solutions, where professional personnel are required for text production, the process of generating video related text in the above technical solution is more intelligent and simpler, requiring less professional knowledge for video production from the video producers, reducing the time and labor costs involved in text generation and reducing the difficulty of generating text content, providing a foundation for subsequent video production.

Further, the object association information is access link information of a video production object.

The apparatus further includes an attribute information generation module, configured to:
access an information page associated with the video production object by the access link information, the information page including object service information of the video production object;
extract and parse the object service information from the information page to obtain the object attribute information of the video production object.

Further, the apparatus further includes a text generation module, configured to:
use the object attribute information as input data, or use the object attribute information and object context information extracted relative to the video production object from a data vector library as input data;
input the input data into a trained text generation model, and determine output text description information as the video related text; and
the video related text comprising video title information and text content to be displayed in the video.

Further, the apparatus further includes an upload interface presentation module and a material presentation module.

The uploading interface presenting module is configured to switch the text setup interface to a material uploading interface in response to a trigger operation on a NEXT execution control in the text setup interface.

The material display module is configured to display a material thumbnail of an uploaded material file in the material uploading interface, the material file being associated with the video production object.

Further, the apparatus further includes a first rollback module and a preview interface presentation module.

The first rollback module is configured to switch from the material uploading interface to the text setup interface to display in response to a trigger operation on a BACK execution control in the material uploading interface.

The preview interface presentation module is configured to in response to a trigger operation on a NEXT execution control in the material uploading interface, switch the material uploading interface to a video preview interface, and display a generated video file in the video preview interface, wherein the video file is generated based on the uploaded material file and is associated with the video production object.

Further, the apparatus further includes a video file generation module, configured to:
in response to that there is one uploaded material file, fuse the material file with the video related text, and perform enhancement processing on video content of a generated fused video to be displayed according to pre-configured video production attribute information to obtain a video file formed after enhancement processing.

Further, the video file generation module is further configured to:
parse the uploaded material files and obtaining predetermined synthesis video configuration information in response to that there are at least two uploaded material files;
divide and crop the uploaded material file according to a material analysis result to form a plurality of material segments corresponding to the material file, and selecting material segments from different material files for material content splicing according to the synthesis video configuration information to generate a plurality of synthesized videos; and
perform a fusion processing on the video related text and different synthesized videos respectively, and perform enhancement processing on video content of a generated fused video to be displayed according to pre-configured video production attribute information to obtain a video file formed after enhancement processing.

Further, the video preview interface includes a display type selection box. The display type selection box includes all video display items, a first screening condition display item, a second screening condition display item, and a conventional video display item.

The apparatus further includes a video presentation module, configured to:
display all generated video files in the video preview interface by using the all video display item as a default display type, present a first screening result label on a first video file satisfying the first screening condition, and present a second screening result label on a second video file satisfying the second screening condition;
determine the first video file satisfying the first screening condition from all of the generated video files, and display the first video file in the video preview interface in a form of carrying the first screening result label in response to a trigger operation on the first screening condition display item;
determine the second video file satisfying the second screening condition from all of the generated video files, and display the second video file in the video preview interface in a form of carrying the second screening result label in response to a trigger operation on the second screening condition display item; and
display other video files than the first video file and the second video file in all of the generated video files in the video preview interface in response to a trigger operation on the conventional video display item.

The first screening condition is different from the screening content included in the second screening condition.

Further, the apparatus further includes a file determining module, configured to:
analyze, for each of the generated video file, a material file source corresponding to video content in the video file;
determine the video file as the first video file satisfying the first screening condition, if none of material files contained in the material file source participates in generation of a further video file;
determine the video file as the second video file satisfying the second screening condition, if a number of material files, which participates in generation of the further video file and belongs to material files comprised in the material file source, is less than a predetermined number.

Further, the file determining module is further configured to:
obtain a material similarity value that the uploaded material file has, the material similarity value being determined by performing similarity calculation on the comprised material content after the material file is uploaded;
determine, for each of the generated video files, a target material file composing the video content in the video file;
determine a video similarity of the video file by performing weighted calculation on the material similarity values of the target material file;
determine the video file as the first video file satisfying the first screening condition in response to that the video similarity is less than a first similarity threshold; and
determine the video file as the second video file satisfying the second screening condition in response to that the video similarity is greater than or equal to the first similarity threshold and less than a second similarity threshold.

Further, the apparatus further includes a video playing module, configured to:
perform video content playback of a corresponding video file in a pop-up video preview playback window in response to a playback trigger operation for any of displayed video files, where the video preview playback window is presented in a created layer, and the layer is above a layer where the video preview interface is located;
or
expand a preview playback area in a converged state in the video preview interface, and display video content of the corresponding video file in the preview display area in response to the playback triggering operation for any of displayed video files, where the preview playback area enters the convergence state after completion of the playing of the video file, and the display area size for displaying the video file is adjusted according to expansion or convergence of the preview playback area.

Further, the apparatus further includes a second rollback module, an export interface generation module, and a video export module.

The second backoff module is configured to switch from the video preview interface to the material uploading interface for display in response to a trigger operation on a BACK execution control in the video preview interface.

The export interface generation module is configured to in response to a trigger operation on a NEXT execution control in the video preview interface, switch the video preview interface to a video export interface, and display a selected video file as a to-be-exported video file in the video export interface.

The selected video file is preselected from video files displayed on the video preview interface.

Further, the apparatus further includes a deduplication module, where before entering the video export node, the deduplication module is configured to:
pop out a video deduplication configuration window, the video deduplication configuration window comprising: a deduplication option and a non-deduplication option;
deduplicate the selected video file, and reserving the deduplicated selected video file in response to receiving a select operation on the deduplication option; and
reserve all selected video files in response to receiving a select operation on the non-deduplication option.

Further, the to-be-exported video file is provided with a hidden operation bar.

The apparatus further includes a content playing module, configured to:
display a corresponding hidden operation bar, the hidden operation bar comprising a video download item and a video view item in response to detecting a hover event on any of to-be-exported video files;
store the to-be-exported video file according to a set storage path in response to a select operation on the video download item; and
play video content of the to-be-exported video file in a pop-up video playback window in response to a select operation on the video view item.

Further, the apparatus further includes a video publishing module, configured to:
present the video publishing control in the video preview interface in response to a trigger operation on a video publishing control; and
obtain a selected video file selected from presented video files, and publish the selected video file as a video publishing file.

Further, the apparatus further includes a policy updating module, configured to:
aggregate playback effect description data generated after publishing the video publishing file; and
update a processing policy involved in video file generation according to the playback effect description data.

The video production apparatus provided by the embodiments of the present disclosure may perform the method for manufacturing a video provided by any embodiment of the present disclosure. The apparatus has functional modules and beneficial effects corresponding to the execution method.

It should be noted that the units and modules included in the foregoing apparatus are only divided according to the function logic, but are not limited to the foregoing division, as long as the corresponding functions may be implemented. in addition, the specific names of the functional units are merely for ease of distinguishing. Moreover, the specific names of the functional units are not intended to limit the protection scope of the embodiments of the present disclosure.

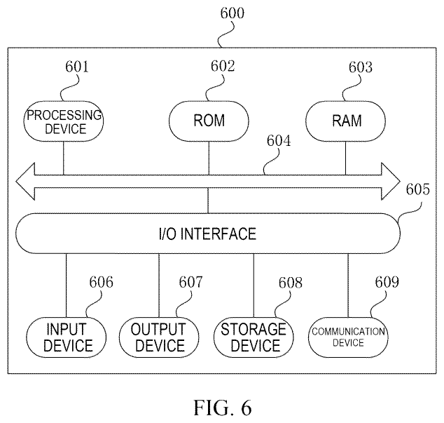

FIG. 6 is a schematic structural diagram of an electronic device provided by embodiments of the present disclosure. Referring specifically to FIG. 6 below, which shows a schematic structural diagram of an electronic device 600 (such as the terminal device or server in FIG. 6) suitable for implementing embodiments of the present disclosure. The terminal device 600 in embodiments of the present disclosure may include but is not limited to mobile terminals such as mobile phones, laptops, digital broadcast receivers, PDAs (personal digital assistants), PADs (tablets), PMPs (portable multimedia players), car terminals (such as car navigation terminals), and fixed terminals such as digital TVs, desktop computers, etc. The electronic device shown in FIG. 6 is only an example and should not bring any limitations on the functionality and scope of use of embodiments of the present disclosure.

As shown in FIG. 6, the electronic device 600 may include a processing device (such as a Central Processor, graphics processing unit, etc.) 601, which may perform various appropriate actions and processes based on programs stored in Read Only Memory (ROM) 602 or programs loaded from storage device 608 into Random Access Memory (RAM) 603. In RAM 603, various programs and data required for the operation of the electronic device 600 are also stored. The processing device 601, ROM 602, and RAM 603 are connected to each other through a bus 604. The edit/output (I/O) interface 605 is also connected to the bus 604.

Typically, the following devices may be connected to the I/O interface 605, including but not limited to, an input device 606 such as touch screens, touchpads, keyboards, mice, cameras, microphones, accelerometers, gyroscopes, etc.; an output device 607 including, for example, liquid crystal displays (LCDs), speakers, vibrators, etc.; a storage device 608 including magnetic tapes, hard disks, etc.; and a communication device 609. The communication device 609 may allow electronic device 600 to communicate via wire or wirelessly with other apparatuses to exchange data. Although FIG. 6 shows an electronic device 600 with various apparatuses, it should be understood that it is not required to implement or have all of the devices shown. More or fewer devices may be implemented or provided instead.

In particular, according to the embodiments of the present disclosure, the process described above with reference to the flowchart may be implemented as a computer software program. For example, the embodiments of the present disclosure include a computer program product that includes a computer program carried on a computer-readable medium, the computer program containing program code for performing the method shown in the flowchart. In such embodiments, the computer program may be downloaded and installed from the network through the communication device 609, or from the storage device 608, or from the ROM 602. When the computer program is executed by the processing device 601, the above functions defined in the methods of the present disclosure are performed. The embodiments of the present disclosure include a computer program that implements the above functions defined in the methods of the present disclosure when executed by a processor.

The names of messages or information interaction between multiple devices in embodiments of the present disclosure are for illustrative purposes only and are not intended to limit the scope of such messages or information.

The electronic device provided by the embodiments of the present disclosure and the video manufacturing method provided in the above embodiments belong to the same inventive concept. Technical details not described in detail in this embodiment may refer to the foregoing embodiments, and the present embodiment has the same beneficial effects as the foregoing embodiments.

An embodiment of the present disclosure provides a computer storage medium having a computer program stored thereon, the program, when executed by a processor, implements the method for manufacturing a video provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs, and when the one or more programs are executed by the electronic device, the electronic device is caused to: present a text setup interface in the displayed video making window, where the text setup interface includes: an information edit area, a first information display area, and a second information display area; receive a first trigger operation. The first trigger operation is to trigger a first trigger control included in the information edit area after inputting object association information of a video production object in an information edit box included in the information edit area; display object attribute information corresponding to the video production object in the first information display area, where the object attribute information is determined based on the object association information; receive a second trigger operation, where the second trigger operation is to trigger a second trigger control included in the first information display area; and display, in the second information display area, video related text corresponding to the video production object, where the video related text is generated based on the object attribute information.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, example 1 provides a method for video production. The method includes:
presenting a text setup interface in a displayed video producing window, the text setup interface including: an information edit area, a first information display area, and a second information display area;
receiving a first trigger operation, where the first trigger operation triggers a first trigger control comprised in the information edit area after object association information of a video production object is inputted to an information edit box included in the information edit area;
displaying object attribute information corresponding to the video production object in the first information display area, the object attribute information being determined based on the object association information;
receiving a second trigger operation, where the second trigger operation triggers a second trigger control comprised in the first information display area; and
displaying, in the second information display area, video related text corresponding to the video production object, the video related text being generated based on the object attribute information.

According to one or more embodiments of the present disclosure, example 2 provides a method for video production, in which the object association information may be optimized as access link information of a video production object.

The step of determining the object attribute information based on the object association information includes:
accessing an information page associated with the video production object by the access link information, the information page including object service information of the video production object;
extracting and parsing the object service information from the information page to obtain the object attribute information of the video production object.

According to one or more embodiments of the present disclosure, example 3 provides a method for video production. The method may optimize the step of generating the video related text based on the object attribute information including:
using the object attribute information as input data, or using the object attribute information object context information extracted relative to the video production object from a data vector library as input data; and
inputting the input data into a trained text generation model, and determining output text description information as the video related text,
wherein the video related text includes video title information and text content to be displayed in the video.

According to one or more embodiments of the present disclosure, example 4 provides a method for video production. The method includes:
Optionally, the method further includes:
in response to a trigger operation on a NEXT execution control in the text setup interface, switching the text setup interface to a material uploading interface;
displaying a material thumbnail of an uploaded material file in the material uploading interface, the material file being associated with the video production object.

According to one or more embodiments of the present disclosure, example 5 provides a method for video production. The method includes:
Optionally, the method further includes:
in response to a trigger operation on a BACK execution control in the material uploading interface, switching from the material uploading interface to the text setup interface to display;
in response to a trigger operation on a NEXT execution control in the material uploading interface, switching the material uploading interface to a video preview interface, and displaying a generated video file in the video preview interface, wherein the video file is generated based on the uploaded material file and is associated with the video production object.

According to one or more embodiments of the present disclosure, example 6 provides a method for video production. Optionally, the method may optimize the step of generating the video file based on the uploaded material file including:
in response to that there is one uploaded material file, fusing the material file with the video related text, and performing enhancement processing on video content of a generated fused video to be displayed according to pre-configured video production attribute information to obtain a video file formed after enhancement processing.

According to one or more embodiments of the present disclosure, example 7 provides a method for video production. The method may optimize the step of generating the video related text based on the uploaded material file including:
in response to that there are at least two uploaded material files, parsing the uploaded material files and obtaining predetermined synthesis video configuration information;
dividing and cropping the uploaded material file according to a material analysis result to form a plurality of material segments corresponding to the material file, and selecting material segments from different material files for material content splicing according to the synthesis video configuration information to generate a plurality of synthesized videos; and
performing a fusion processing on the video related text and different synthesized videos respectively, and performing enhancement processing on video content of a generated fused video to be displayed according to pre-configured video production attribute information to obtain a video file formed after enhancement processing.

According to one or more embodiments of the present disclosure, example 8 provides a video production method, which may optimize a display type selection box in the video preview interface. The display type selection box includes: all video display items, a first screening condition display item, a second screening condition display item, and a conventional video display item;

Optionally, the displaying a video file of the generated video file in the video preview interface includes:
displaying all generated video files in the video preview interface by using the all video display item as a default display type, presenting a first screening result label on a first video file satisfying the first screening condition, and presenting a second screening result label on a second video file satisfying the second screening condition;
in response to a trigger operation on the first screening condition display item, determining the first video file satisfying the first screening condition from all of the generated video files, and displaying the first video file in the video preview interface in a form of carrying the first screening result label;
in response to a trigger operation on the second screening condition display item, determining the second video file satisfying the second screening condition from all of the generated video files, and displaying the second video file in the video preview interface in a form of carrying the second screening result label; and
in response to a trigger operation on the conventional video display item, displaying other video files than the first video file and the second video file in all of the generated video files in the video preview interface.

The first screening condition is different from the screening content included in the second screening condition.

According to one or more embodiments of the present disclosure, example 9 provides a method for video production. The method may optimize the step of determining the first video file and the second video file from the generated video files by including:
analyzing, for each generated video file, a material file source corresponding to video content in the video file;
if none of the material files included in the source file source participates in other video file generation, determining the video file as the first video file satisfying the first screening condition; and
determining the video file as the second video file satisfying the second screening condition if the material file contained in the material file source has less than the set number of material files involved in other video file generation.

According to one or more embodiments of the present disclosure, example 10 provides a method for video production. The method may optimize the step of determining the first video file and the second video file from the generated video files including:
obtaining a material similarity value that the uploaded material file has, the material similarity value being determined by performing similarity calculation on the comprised material content after the material file is uploaded;
determining, for each of the generated video files, a target material file composing the video content in the video file;
determining a video similarity of the video file by performing weighted calculation on the material similarity values of the target material file;
in response to that the video similarity is less than a first similarity threshold, determining the video file as the first video file satisfying the first screening condition; and
in response to that the video similarity is greater than or equal to the first similarity threshold and less than a second similarity threshold, determining the video file as the second video file satisfying the second screening condition.

According to one or more embodiments of the present disclosure, example 11 provides a method for video production. The method may optimize, further including:
in response to a playback trigger operation for any of displayed video files, performing video content playback of a corresponding video file in a pop-up video preview playback window, wherein the video preview playback window is presented in a created layer, and the layer is above a layer where the video preview interface is located;
or
in response to the playback triggering operation for any of displayed video files, expanding a preview playback area in a converged state in the video preview interface, and displaying video content of the corresponding video file in the preview display area, wherein the preview playback area enters the convergence state after completion of the playing of the video file, and the display area size for displaying the video file is adjusted according to expansion or convergence of the preview playback area.

According to one or more embodiments of the present disclosure, example 12 provides a method for video production. The method may optimize, further including:
in response to a trigger operation on a BACK execution control in the video preview interface, switching from the video preview interface to the material uploading interface for display;
in response to a trigger operation on a NEXT execution control in the video preview interface, switching the video preview interface to a video export interface, and displaying a selected video file as a to-be-exported video file in the video export interface,
wherein the selected video file is preselected from video files displayed on the video preview interface.

According to one or more embodiments of the present disclosure, example 13 provides a method for video production. The method may optimize before switching the video preview interface to the video export interface, the method further includes:
popping out a video deduplication configuration window, the video deduplication configuration window comprising: a deduplication option and a non-deduplication option;
in response to receiving a select operation on the deduplication option, deduplicating the selected video file, and reserving the deduplicated selected video file; and
in response to receiving a select operation on the non-deduplication option, reserving all selected video files.

According to one or more embodiments of the present disclosure, example 14 provides a method for video production. The method may optimize the to-be-exported video file is provided with a hidden operation bar;
the method further including:
in response to detecting a hover event on any of to-be-exported video files, displaying a corresponding hidden operation bar, the hidden operation bar comprising a video download item and a video view item;
in response to a select operation on the video download item, storing the to-be-exported video file according to a set storage path; and
in response to a select operation on the video view item, playing video content of the to-be-exported video file in a pop-up video playback window.

According to one or more embodiments of the present disclosure, example 15 provides a method for video production. The method may optimize, further including:
in response to a trigger operation on a video publishing control, presenting the video publishing control in the video preview interface; and
obtaining a selected video file selected from presented video files, and publishing the selected video file as a video publishing file.

According to one or more embodiments of the present disclosure, example 16 provides a method for video production. The method may optimize, further including:
aggregating playback effect description data generated after publishing the video publishing file; and
updating a processing policy involved in video file generation according to the playback effect description data.

According to one or more embodiments of the present disclosure, example 17 provides an apparatus for video production. The apparatus includes:
a setup interface presenting module configured to present a text setup interface in a displayed video producing window, the text setup interface comprising: an information edit area, a first information display area, and a second information display area;
a first receiving module configured to receive a first trigger operation, wherein the first trigger operation triggers a first trigger control comprised in the information edit area after object association information of a video production object is inputted to an information edit box included in the information edit area;
a first display module configured to display object attribute information corresponding to the video production object in the first information display area, the object attribute information being determined based on the object association information;
a second receiving module configured to receive a second trigger operation, wherein the second trigger operation triggers a second trigger control comprised in the first information display area; and
a second display module configured to display, in the second information display area, video related text corresponding to the video production object, the video related text being generated based on the object attribute information.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method for producing a video, comprising:
presenting a text setup interface in a displayed video producing window, the text setup interface comprising: an information edit area, a first information display area, and a second information display area;
receiving a first trigger operation, wherein the first trigger operation triggers a first trigger control comprised in the information edit area after object association information of a video production object is inputted to an information edit box included in the information edit area;
displaying object attribute information corresponding to the video production object in the first information display area, the object attribute information being determined based on the object association information;
receiving a second trigger operation, wherein the second trigger operation triggers a second trigger control comprised in the first information display area; and
displaying, in the second information display area, video related text corresponding to the video production object, the video related text being generated based on the object attribute information.

2. The method of claim 1, wherein the object association information is access link information of the video production object, and a step of determining the object attribute information based on the object association information comprises:
accessing an information page associated with the video production object by the access link information, the information page including object service information of the video production object; and
extracting and parsing the object service information from the information page to obtain the object attribute information of the video production object.

3. The method of claim 1, wherein a step of generating the video related text based on the object attribute information comprises:
using the object attribute information as input data, or using the object attribute information and object context information extracted relative to the video production object from a data vector library as input data;
inputting the input data into a trained text generation model, and determining output text description information as the video related text; and
the video related text comprising video title information and text content to be displayed in the video.

4. The method of claim 1, further comprising:
in response to a trigger operation on a NEXT execution control in the text setup interface, switching the text setup interface to a material uploading interface; and
displaying a material thumbnail of an uploaded material file in the material uploading interface, the material file being associated with the video production object.

5. The method of claim 4, further comprising:
in response to a trigger operation on a BACK execution control in the material uploading interface, switching from the material uploading interface to the text setup interface to display; and
in response to a trigger operation on a NEXT execution control in the material uploading interface, switching the material uploading interface to a video preview interface, and displaying a generated video file in the video preview interface, wherein the video file is generated based on the uploaded material file and is associated with the video production object.

6. The method of claim 5, wherein a step of generating the video file based on the uploaded material file comprises:
in response to that there is one uploaded material file, fusing the material file with the video related text, and performing enhancement processing on video content of a generated fused video to be displayed according to pre-configured video production attribute information to obtain a video file formed after enhancement processing.

7. The method of claim 5, wherein a step of generating the video file based on the uploaded material file comprises:
in response to that there are at least two uploaded material files, parsing the uploaded material files and obtaining predetermined synthesis video configuration information;
dividing and cropping the uploaded material file according to a material analysis result to form a plurality of material segments corresponding to the material file, and selecting material segments from different material files for material content splicing according to the synthesis video configuration information to generate a plurality of synthesized videos; and
performing a fusion processing on the video related text and different synthesized videos respectively, and performing enhancement processing on video content of a generated fused video to be displayed according to pre-configured video production attribute information to obtain a video file formed after enhancement processing.

8. The method of claim 5, wherein the video preview interface comprises a display type selection box, the display type selection box comprising: an all video display item, a first screening condition display item, a second screening condition display item, and a conventional video display item; and
the displaying a generated video file in the video preview interface comprises:
displaying all generated video files in the video preview interface by using the all video display item as a default display type, presenting a first screening result label on a first video file satisfying the first screening condition, and presenting a second screening result label on a second video file satisfying the second screening condition;
in response to a trigger operation on the first screening condition display item, determining the first video file satisfying the first screening condition from all of the generated video files, and displaying the first video file in the video preview interface in a form of carrying the first screening result label;
in response to a trigger operation on the second screening condition display item, determining the second video file satisfying the second screening condition from all of the generated video files, and displaying the second video file in the video preview interface in a form of carrying the second screening result label; and
in response to a trigger operation on the conventional video display item, displaying other video files than the first video file and the second video file in all of the generated video files in the video preview interface;
wherein screening content comprised in the first screening condition is different from screening content comprised in the second screening condition.

9. The method of claim 8, wherein a step of determining the first video file and the second video file from the generated video files comprises:
analyzing, for each of the generated video file, a material file source corresponding to video content in the video file;
if none of material files contained in the material file source participates in generation of a further video file, determining the video file as the first video file satisfying the first screening condition; and
if a number of material files, which participates in generation of the further video file and belongs to material files comprised in the material file source, is less than a predetermined number, determining the video file as the second video file satisfying the second screening condition.

10. The method of claim 8, wherein a step of determining the first video file and the second video file from the generated video files comprises:
obtaining a material similarity value that the uploaded material file has, the material similarity value being determined by performing similarity calculation on the comprised material content after the material file is uploaded;
determining, for each of the generated video files, a target material file composing the video content in the video file;
determining a video similarity of the video file by performing weighted calculation on the material similarity values of the target material file;
in response to that the video similarity is less than a first similarity threshold, determining the video file as the first video file satisfying the first screening condition; and
in response to that the video similarity is greater than or equal to the first similarity threshold and less than a second similarity threshold, determining the video file as the second video file satisfying the second screening condition.

11. The method of claim 5, further comprising:
in response to a playback trigger operation for any of displayed video files, performing video content playback of a corresponding video file in a pop-up video preview playback window, wherein the video preview playback window is presented in a created layer, and the layer is above a layer where the video preview interface is located; or
in response to the playback triggering operation for any of displayed video files, expanding a preview playback area in a converged state in the video preview interface, and displaying video content of the corresponding video file in the preview display area, wherein the preview playback area enters the convergence state after completion of the playing of the video file, and the display area size for displaying the video file is adjusted according to expansion or convergence of the preview playback area.

12. The method of claim 5, further comprising:
in response to a trigger operation on a BACK execution control in the video preview interface, switching from the video preview interface to the material uploading interface for display; and
in response to a trigger operation on a NEXT execution control in the video preview interface, switching the video preview interface to a video export interface, and displaying a selected video file as a to-be-exported video file in the video export interface,
wherein the selected video file is preselected from video files displayed on the video preview interface.

13. The method of claim 12, wherein before switching the video preview interface to the video export interface, the method further comprises:
popping out a video deduplication configuration window, the video deduplication configuration window comprising: a deduplication option and a non-deduplication option;
in response to receiving a select operation on the deduplication option, deduplicating the selected video file, and reserving the deduplicated selected video file; and
in response to receiving a select operation on the non-deduplication option, reserving all selected video files.

14. The method of claim 12, wherein the to-be-exported video file is provided with a hidden operation bar;
the method further comprising:
in response to detecting a hover event on any of to-be-exported video files, displaying a corresponding hidden operation bar, the hidden operation bar comprising a video download item and a video view item;
in response to a select operation on the video download item, storing the to-be-exported video file according to a set storage path; and
in response to a select operation on the video view item, playing video content of the to-be-exported video file in a pop-up video playback window.

15. The method of claim 5, further comprising:
in response to a trigger operation on a video publishing control, presenting the video publishing control in the video preview interface; and
obtaining a selected video file selected from presented video files, and publishing the selected video file as a video publishing file.

16. The method of claim 15, further comprising:
aggregating playback effect description data generated after publishing the video publishing file; and
updating a processing policy involved in video file generation according to the playback effect description data.

17. An electronic device, comprising:
one or more processors; and
a storage device configured to store one or more programs;
wherein the one or more programs, when executed by the one or more processors, cause the one or more processors to implement acts comprising:
presenting a text setup interface in a displayed video producing window, the text setup interface comprising: an information edit area, a first information display area, and a second information display area;
receiving a first trigger operation, wherein the first trigger operation triggers a first trigger control comprised in the information edit area after object association information of a video production object is inputted to an information edit box included in the information edit area;
displaying object attribute information corresponding to the video production object in the first information display area, the object attribute information being determined based on the object association information;
receiving a second trigger operation, wherein the second trigger operation triggers a second trigger control comprised in the first information display area; and
displaying, in the second information display area, video related text corresponding to the video production object, the video related text being generated based on the object attribute information.

18. The device of claim 17, wherein the object association information is access link information of the video production object, and a step of determining the object attribute information based on the object association information comprises:
accessing an information page associated with the video production object by the access link information, the information page including object service information of the video production object; and
extracting and parsing the object service information from the information page to obtain the object attribute information of the video production object.

19. The device of claim 17, wherein a step of generating the video related text based on the object attribute information comprises:
using the object attribute information as input data, or using the object attribute information and object context information extracted relative to the video production object from a data vector library as input data;
inputting the input data into a trained text generation model, and determining output text description information as the video related text; and
the video related text comprising video title information and text content to be displayed in the video.

20. A non-transitory computer-readable storage medium with a computer program stored thereon, wherein the computer program, when executed by a processor, implements acts comprising:
presenting a text setup interface in a displayed video producing window, the text setup interface comprising: an information edit area, a first information display area, and a second information display area;
receiving a first trigger operation, wherein the first trigger operation triggers a first trigger control comprised in the information edit area after object association information of a video production object is inputted to an information edit box included in the information edit area;
displaying object attribute information corresponding to the video production object in the first information display area, the object attribute information being determined based on the object association information;
receiving a second trigger operation, wherein the second trigger operation triggers a second trigger control comprised in the first information display area; and
displaying, in the second information display area, video related text corresponding to the video production object, the video related text being generated based on the object attribute information.
